(19) United States
(12) Patent Application Publication
(10) Pub. No.: US 2026/0219444 A1
(43) Pub. Date: Jul. 30, 2026

(54) COMPLEX STRUCTURE RESONATOR, PHOTONIC INTEGRATED CIRCUIT INCLUDING THE COMPLEX STRUCTURE RESONATOR, AND METHOD OF MANUFACTURING THE PHOTONIC INTEGRATED CIRCUIT

(71) Applicant: SAMSUNG ELECTRONICS CO., LTD., Suwon-si (KR)

(72) Inventor: Changgyun Shin, Suwon-si (KR)

(73) Assignee: SAMSUNG ELECTRONICS CO., LTD., Suwon-si (KR)

(21) Appl. No.: 19/410,719

(22) Filed: Dec. 5, 2025

(30) Foreign Application Priority Data
Jan. 24, 2025 (KR) 10-2025-0011693
Apr. 30, 2025 (KR) 10-2025-0057750

(51) Int. Cl. G02B 6/12; G02B 6/293

(52) U.S. Cl. CPC G02B 6/12007; G02B 6/29338

(57) ABSTRACT

Provided is a complex structure resonator including an outer ring resonator on a substrate, the outer ring resonator being configured to be optically coupled to a waveguide, and a closed inner resonator inside the outer ring resonator, wherein the closed inner resonator includes a first curved portion at a first distance from the outer ring resonator, the first curved portion being configured to be optically coupled to the outer ring resonator, and a second curved portion at a second distance from the outer ring resonator, the second distance being greater than the first distance.

### CROSS-REFERENCE TO RELATED APPLICATION

This application claims priority to Korean Patent Application Nos. 10-2025-0011693, filed on January 24, 2025, and 10-2025-0057750, filed on April 30, 2025, in the Korean Intellectual Property Office, the disclosures of which are incorporated by reference herein in their entireties.

### BACKGROUND

### 1.Field

Embodiments of the present disclosure relate to a complex structure resonator, a photonic integrated circuit (PIC) including the complex structure resonator, and a method of manufacturing the PIC.

### Description of Related Art

Optical interconnect structures for high-speed, large-capacity data transmission require photonic integrated circuits (PICs) in which optical devices, such as light sources, optical modulators, optical filters, and optical waveguides, are integrated on a single substrate. In addition, mass transmission of optical signals is performed by wavelength division multiplexing (WDM) scheme and requires PICs in which a plurality of different wavelengths are used as individual transmission channels.

In PICs, ring resonators may act as optical filters and optical modulators and may block or reflect only light of specific wavelengths that satisfy resonance conditions. Since the frequency interval at which the ring resonator operates is inversely proportional to the size of the ring resonator, the size of the ring resonator has to increase so as to construct more transmission channels in a given wavelength range. However, there is a need for miniaturized optical devices applied to PICs.

### SUMMARY

One or more embodiments provide a miniaturized complex structure resonator capable of constructing more transmission channels in a given wavelength range, a photonic integrated circuit (PIC) including the miniaturized complex structure resonator, and a method of manufacturing the PIC.

Additional aspects will be set forth in part in the description which follows and, in part, will be apparent from the description, or may be learned by practice of one or more embodiments.

According to an aspect of one or more embodiments, there is provided a complex structure resonator including an outer ring resonator on a substrate, the outer ring resonator being configured to be optically coupled to a waveguide, and a closed inner resonator inside the outer ring resonator, wherein the closed inner resonator includes a first curved portion at a first distance from the outer ring resonator, the first curved portion being configured to be optically coupled to the outer ring resonator, and a second curved portion at a second distance from the outer ring resonator, the second distance being greater than the first distance.

The closed inner resonator may include a plurality of first curved portions and a plurality of second curved portions that are alternately provided.

The outer ring resonator may have a deformed circular shape.

An effective optical path length of the outer ring resonator may be equal to an effective optical path length of the closed inner resonator.

The waveguide may include a first waveguide on a first side of the outer ring resonator, the first waveguide being configured to be optically coupled to the outer ring resonator, and a second waveguide on a second side of the outer ring resonator, the second waveguide being configured to be optically coupled to the outer ring resonator.

A free spectral range of the complex structure resonator may be smaller than a free spectral range of the outer ring resonator.

The free spectral range of the complex structure resonator may be half the free spectral range of the outer ring resonator.

According to another aspect of one or more embodiments, there is provided a photonic integrated circuit (PIC) including a substrate, a waveguide on the substrate and configured to transmit light, and a complex structure resonator including an outer ring resonator on the substrate, the outer ring resonator being configured to be optically coupled to the waveguide, and a closed inner resonator inside the outer ring resonator, wherein the closed inner resonator includes a first curved portion at a first distance from the outer ring resonator, the first curved portion being configured to be optically coupled to the outer ring resonator, and a second curved portion at a second distance from the outer ring resonator, the second distance being greater than the first distance.

The closed inner resonator may include a plurality of first curved portions and a plurality of second curved portions that are alternately provided.

The outer ring resonator may have a deformed circular shape.

An effective optical path length of the outer ring resonator may be equal to an effective optical path length of the closed inner resonator.

A free spectral range of the complex structure resonator may be smaller than a free spectral range of the outer ring resonator.

The free spectral range of the complex structure resonator may be half the free spectral range of the outer ring resonator.

The waveguide may include a first waveguide on a first side of the outer ring resonator of the complex structure resonator, the first waveguide being configured to be optically coupled to the outer ring resonator of the complex structure resonator, and a second waveguide on a second side of the outer ring resonator of the complex structure resonator, the second waveguide being configured to be optically coupled to the outer ring resonator of the complex structure resonator.

The complex structure resonator may include a plurality of complex structure resonators along the first waveguide, the plurality of complex structure resonators being configured to be optically coupled to the first waveguide, and the second waveguide may include a plurality of second waveguides corresponding to the plurality of complex structure resonators, respectively, the plurality of second waveguides being configured to be optically coupled to the plurality of complex structure resonators, respectively.

The PIC may further include at least one optical element being configured to be optically coupled to the complex structure resonator.

The at least one optical element may include at least one of a ring modulator, an optical coupler, and an optical amplifier.

According to yet another aspect of one or more embodiments, there is provided a method of manufacturing a photonic integrated circuit (PIC), the method including preparing a substrate including a silicon layer on an upper surface of the substrate, and patterning the silicon layer of the substrate to form a complex structure resonator and a waveguide, the complex structure resonator including a closed inner resonator and an outer ring resonator, and the waveguide being configured to be optically coupled to the outer ring resonator of the complex structure resonator, wherein the closed inner resonator includes a first curved portion at a first distance from the outer ring resonator, the first curved portion being configured to be optically coupled to the outer ring resonator, and a second curved portion at a second distance from the outer ring resonator, the second distance being greater than the first distance.

The closed inner resonator may include a plurality of first curved portions and a plurality of second curved portions that are alternately provided, and the outer ring resonator may have a deformed circular shape.

An effective optical path length of the outer ring resonator may be equal to an effective optical path length of the closed inner resonator.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a perspective view schematically illustrating a complex structure resonator and a photonic integrated circuit (PIC) including the same, according to one or more embodiments;

FIG. 2 is a schematic plan view of FIG. 1;

FIG. 3 is a schematic cross-sectional view taken along line A-A’ of FIG. 2;

FIG. 4 is a plan view schematically illustrating a ring resonator of Related Example 1;

FIG. 5 is a plan view schematically illustrating a ring resonator of Related Example 2;

FIG. 6 is a graph showing transmission spectra of the ring resonator of Related Example 1 of FIG. 4 and the ring resonator of Related Example 2 of FIG. 5;

FIG. 7 shows a transmission spectrum of the ring resonator of Related Example 2 of FIG. 5 and a transmission spectrum of the complex structure resonator according to one or more embodiments;

FIG. 8 is a plan view schematically illustrating a complex structure resonator and a PIC including the same, according to one or more embodiments;

FIG. 9 is a cross-sectional view taken along line B-B’ of FIG. 8;FIG. 10 is a plan view schematically illustrating a complex structure resonator and a PIC including the same, according to one or more embodiments;

FIG. 11 is a plan view schematically illustrating a PIC including complex structure resonators, according to one or more embodiments;

FIG. 12 is a plan view schematically illustrating a PIC including complex structure resonators, according to one or more embodiments; and

FIG. 13 is a block diagram illustrating a schematic configuration of a photoelectronic device according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, or all of a, b, and c.

Hereinafter, embodiments will be described in detail with reference to the accompanying drawings. In the following drawings, the same reference numerals denote the same elements, and the size of each element in the drawings may be exaggerated for clarity and convenience of explanation. Embodiments described herein are merely examples and various modifications may be made thereto from these embodiments.

Hereinafter, the terms “above” or “on” may include not only those that are directly above, below, left, or right in a contact manner, but also those that are above, below, left, or right in a non-contact manner. The singular forms as used herein are intended to include the plural forms as well unless the context clearly indicates otherwise. It will be understood that the terms “comprise,” “include,” or “have” as used herein specify the presence of stated elements, but do not preclude the presence or addition of one or more other elements.

The use of the term “the” and similar demonstratives may correspond to both the singular and the plural. Operations constituting methods may be performed in any suitable order unless otherwise indicated herein or otherwise clearly contradicted by context, and are not necessarily limited to the stated order.

Also, the terms such as “unit” and “module” described in the specification mean units that process at least one function or operation, and may be implemented as hardware, software, or a combination of hardware and software.

Connecting lines or connecting members illustrated in the drawings are intended to represent exemplary functional relationships and/or physical or logical connections between the various elements. It should be noted that many alternative or additional functional relationships, physical connections or logical connections may be present in a practical device.

The use of all illustrations or illustrative terms in the embodiments is simply to describe the technical ideas in detail, and the scope of the inventive concept is not limited by the illustrations or illustrative terms unless they are limited by claims.

A ring resonator may act as an optical filter or an optical modulator in a photonic integrated circuit (PIC). The ring resonator may block or reflect light of a specific wavelength that satisfies resonance conditions. Due to characteristics of the ring resonator, a plurality of frequencies with constant intervals may be filtered. The interval of frequencies at which the ring resonator operates is referred to as a free spectral range (fsr) and is inversely proportional to the circumferential length of the ring resonator. The size of the ring resonator has to increase so as to satisfy the resonance conditions for more wavelengths in a given range, that is, so as to have a denser fsr. For example, a ring resonator filter with an fsr of 1.3 nm has a radius of about 100 μm or more, which is relatively large for an operating element, and occupies a large area for operation and consumes high power for operation.

A complex structure resonator according to one or more embodiments may be configured to operate as an optical filter or an optical modulator, similar to the ring resonator in the PIC, and block or reflect light of a specific wavelength that satisfies resonance conditions. The complex structure resonator according to one or more embodiments may be provided to have a relatively small size and a dense fsr, so as to satisfy resonance conditions for more wavelengths in a given range. The complex structure resonator according to one or more embodiments may be formed as a dual structure resonator in which another resonator structure is provided inside a ring resonator structure. The complex structure resonator according to one or more embodiments may obtain a relatively narrow fsr without increasing the circumference of the resonator structure due to the interaction of two resonator structures.

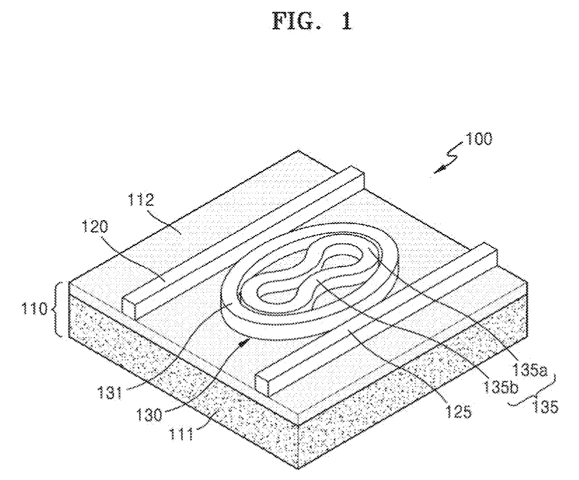

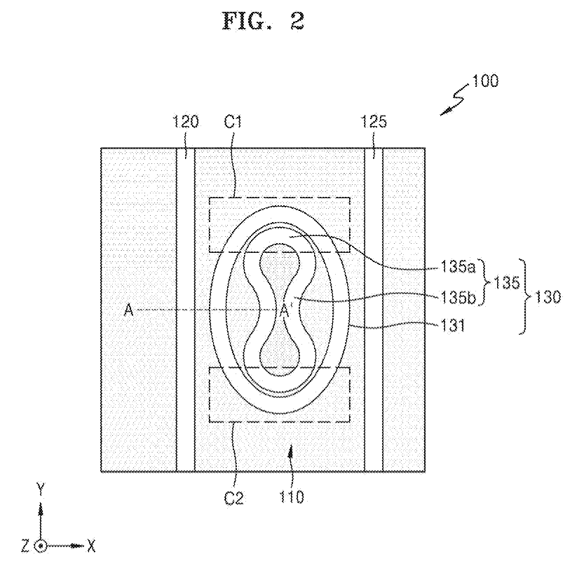

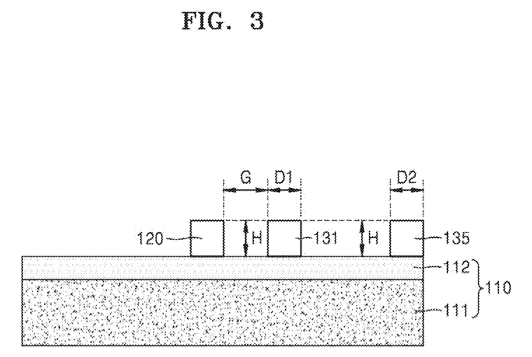

FIG. 1 is a perspective view schematically illustrating a complex structure resonator 130 and a PIC 100 including the same, according to one or more embodiments. FIG. 2 is a schematic plan view of FIG. 1. FIG. 3 is a schematic cross-sectional view taken along line A-A’ of FIG. 2.

Referring to FIGS. 1 to 3, the complex structure resonator 130 may be provided on a substrate 110 and may be provided to be optically coupled to waveguides 120 and 125. The complex structure resonator 130 may include an outer ring resonator 131 optically coupled to the waveguides 120 and 125 and a closed inner resonator 135 arranged inside the outer ring resonator 131. The outer ring resonator 131 and the closed inner resonator 135 may be provided to be optically coupled to each other at a plurality of points C1 and C2. The PIC 100 may include the substrate 110, the waveguides 120 and 125 provided on the substrate 110 and configured to transmit light, and the complex structure resonator 130 provided on the substrate 110 and optically coupled to the waveguides 120 and 125. The waveguides 120 and 125 may include, for example, a first waveguide 120 and a second waveguide 125. Hereinafter, an example in which the waveguides 120 and 125 include the first waveguide 120 and the second waveguide 125 is illustrated and described, but embodiments are not limited thereto. For example, the complex structure resonator 130 may be provided to be optically coupled to at least one waveguide, and the at least one waveguide may include one waveguide, two waveguides, or three or more waveguides.

Herein, a direction parallel to a main surface of the substrate 110 may be referred to as a horizontal direction (X direction and/or Y direction), and a direction perpendicular to the horizontal direction (X direction and/or Y direction) may be referred to as a vertical direction (Z direction).

The waveguides 120 and 125 may include the first waveguide 120 and the second waveguide 125, and each of the first waveguide 120 and the second waveguide 125 may be optically coupled to the outer ring resonator 131 of the complex structure resonator 130. The first waveguide 120 may be arranged on a first side of the outer ring resonator 131 of the complex structure resonator 130, and the second waveguide 125 may be arranged on a second side of the outer ring resonator 131 of the complex structure resonator 130 opposite to the first side of the outer ring resonator 131. One of the first and second waveguides 120 and 125 may correspond to a signal waveguide to which an optical signal is input, and the other may correspond to a transmission waveguide.

For example, when the complex structure resonator 130 operates as a ring filter and optical signals are transmitted through the first waveguide 120, an optical signal of a desired wavelength among the optical signals transmitted through the first waveguide 120 may be transmitted to the second waveguide 125 through the complex structure resonator 130, and optical signals of wavelengths other than the desired wavelength may be passed through as is. In this case, the first waveguide 120 may correspond to a through path as the signal waveguide, and the second waveguide 125 may correspond to a drop path as the transmission waveguide. As another example, when the complex structure resonator 130 operates as a ring filter and optical signals are transmitted through the second waveguide 125, an optical signal of a desired wavelength among the optical signals transmitted through the second waveguide 125 may be transmitted to the first waveguide 120 through the complex structure resonator 130, and optical signals of wavelengths other than the desired wavelength may be passed through as is. In this case, the first waveguide 120 may correspond to a drop path as the transmission waveguide, and the second waveguide 125 may correspond to a through path as the signal waveguide. The optical signal of the desired wavelength may correspond to, for example, an optical signal of a wavelength that satisfies resonance conditions of the complex structure resonator 130.

The substrate 110 may include a first material layer 111, for example, a first silicon layer, and may include an insulating layer 112 on an upper surface of the first material layer 111. The insulating layer 112 may include, for example, silicon oxide. For example, the substrate 110 may include the first silicon layer and the insulating layer 112 may be formed by oxidizing the surface of the substrate 110, but embodiments are not limited thereto. The insulating layer 112 may include an insulating material other than silicon oxide, for example, silicon nitride. When the substrate 110 includes the first silicon layer and the insulating layer 112 on the upper surface of the first silicon layer, a second material layer, for example, a second silicon layer, may be deposited on the insulating layer 112, and the complex structure resonator 130 and the waveguides 120 and 125 may be formed by patterning all or part of the thickness of the second material layer. The complex structure resonator 130 and the PIC 100 including the same, as illustrated in FIGS. 1 to 3, may correspond to the complex structure resonator 130 and the waveguides 120 and 125, which are formed by patterning the entire thickness of the second material layer.

The substrate 110 may be, for example, a silicon on insulation (SOI) substrate. For example, the substrate 110 may include a first silicon layer (corresponding to the first material layer 111), an insulating layer (corresponding to the insulating layer 112), and a second silicon layer, which are sequentially stacked in this stated order. When the substrate 110 is an SOI substrate, the insulating layer 112 may be an insulating layer of the SOI substrate. The complex structure resonator 130 and the waveguides 120 and 125 may be formed by patterning the second silicon layer of the SOI substrate. The complex structure resonator 130 and the waveguides 120 and 125 may be formed by patterning all or part of the second silicon layer of the SOI substrate. The complex structure resonator 130 and the PIC 100 including the same, as illustrated in FIGS. 1 to 3, may correspond to the complex structure resonator 130 and the waveguides 120 and 125, which are formed by patterning the entire thickness of the second silicon layer.

As another example, the substrate 110 may be an insulating substrate. In this case, the insulating layer 112 may be omitted, a second material layer, for example, a second silicon layer, may be deposited on the substrate 110, and the complex structure resonator 130 and the waveguides 120 and 125 may be formed by patterning all or part of the thickness of the second material layer.

The second material layer, for example, a semiconductor layer such as the second silicon layer, may be formed on the substrate 110, and the complex structure resonator 130 and the waveguides 120 and 125 may be formed by patterning all or part of the thickness of the second material layer.

The complex structure resonator 130 may be formed on the substrate 110 so that the outer ring resonator 131 is spaced apart from the waveguides 120 and 125 by a certain distance and is optically coupled to the waveguides 120 and 125. A gap (e.g., G in FIG. 2) between the waveguides 120 and 125 and the complex structure resonator 130 may refer to a gap at a position where the waveguides 120 and 125 and the outer ring resonator 131 of the complex structure resonator 130 are closest to each other. In FIG. 3, G represents a gap between the outer ring resonator 131 of the complex structure resonator 130 and the waveguides 120 and 125, H represents layer thicknesses of the waveguides 120 and 125 in the vertical direction (Z direction), and the outer ring resonator 131 and the closed inner resonator 135 of the complex structure resonator 130, D1 represents a width of the outer ring resonator 131, and D2 represents a width of the closed inner resonator 135 in the horizontal direction (X direction and/or Y direction). A gap between the waveguide 125 and the outer ring resonator 131 of the complex structure resonator 130 may also be G and may have a different value. As illustrated in FIG. 3, the layer thicknesses of the waveguides 120 and 125, and the outer ring resonator 131 and the closed inner resonator 135 of the complex structure resonator 130 may be equal to each other, but embodiments are not limited thereto. The layer thicknesses of the waveguides 120 and 125 may be different from the layer thicknesses of the outer ring resonator 131 and the closed inner resonator 135 of the complex structure resonator 130. Furthermore, the layer thickness of the outer ring resonator 131 of the complex structure resonator 130 may be different from the layer thickness of the closed inner resonator 135 of the complex structure resonator 130. FIG. 3 illustrates that the width D1 of the outer ring resonator 131 of the complex structure resonator 130 is equal to or similar to the width D2 of the closed inner resonator 135 of the complex structure resonator 130, but embodiments are not limited thereto. For example, the width D2 of the closed inner resonator 135 may be greater than the width D1 of the outer ring resonator 131. For example, D1=D2 or D1<D2. As another example, when the layer thickness of the closed inner resonator 135 is greater than the layer thickness of the outer ring resonator 131, D1 may be greater than D2. That is, D1>D2.

The waveguides 120 and 125 and the complex structure resonator 130 may include the same material. The waveguides 120 and 125 and the complex structure resonator 130 may each include, for example, a silicon material. When the substrate 110 is, for example, an SOI substrate, the waveguides 120 and 125 and the complex structure resonator 130 may be formed by patterning the second silicon layer on the insulating layer 112, and thus, the waveguides 120 and 125 and the complex structure resonator 130 may each be formed of a silicon material. When the substrate 110 is an insulating substrate, the waveguides 120 and 125 and the complex structure resonator 130 may each be formed of a silicon material by stacking the second silicon layer on the substrate 110 and patterning the second silicon layer.

The outer ring resonator 131 of the complex structure resonator 130 may have a shape deformed from a circular shape, for example, an elliptical shape. However, embodiments are not limited thereto and the outer ring resonator 131 of the complex structure resonator 130 may have other shapes. The closed inner resonator 135 of the complex structure resonator 130 may include a first curved portion 135a and a second curved portion 135b. Optical coupling to the outer ring resonator 131 may be provided at the first curved portion 135a. To this end, the first curved portion 135a may be formed to have flexure toward the outer ring resonator 131 so as to be relatively close to the outer ring resonator 131, thereby providing optical coupling to the outer ring resonator 131 in at least some regions. The second curved portion 135b may not be relatively close to the outer ring resonator 131. For example, the first curved portion 135a may be at a first distance from the outer ring resonator 131 and the second curved portion 135b may be at a second distance from the outer ring resonator 131 that is greater than the first distance. The second curved portion 135b may have, for example, inward flexure so as to increase the circumference of the closed inner resonator 135. The second curved portion 135b may extend from the first curved portion 135a and the first curved portion 135a may extend from the second curved portion 135b, which may form the closed inner resonator 135.

The closed inner resonator 135 may include a plurality of first curved portions 135a and a plurality of second curved portions 135b and may have a shape in which the first curved portion 135a and the second curved portion 135b are alternately arranged. Accordingly, optical coupling between the closed inner resonator 135 and the outer ring resonator 131 may be provided at at least two points C1 and C2.

FIGS. 1 and 2 illustrate an example in which the closed inner resonator 135 includes two first curved portions 135a and two second curved portions 135b, but embodiments are not limited thereto. The closed inner resonator 135 may include three or more first curved portions 135a and three or more second curved portions 135b. Even in this case, the closed inner resonator 135 may have a shape in which the first curved portion 135a and the second curved portion 135b are alternately arranged.

The complex structure resonator 130 may be provided so that an effective optical path length of the outer ring resonator 131 is equal to an effective optical path length of the closed inner resonator 135. To this end, a material, a layer thickness, and the width D1 of the outer ring resonator 131 and a material, a layer thickness, and the width D2 of the closed inner resonator 135 may be controlled.

For example, the outer ring resonator 131 and the closed inner resonator 135 may be formed of the same material and have the same layer thickness H and the same width (D1=D2). In this case, the outer ring resonator 131 and the closed inner resonator 135 may be formed to have the same circumferential length, and thus, the effective optical path length of the outer ring resonator 131 may be equal to the effective optical path length of the closed inner resonator 135.

As another example, the outer ring resonator 131 and the closed inner resonator 135 may be formed of the same material and have the same layer thickness H, and the width D2 of the closed inner resonator 135 may be formed to be greater than the width D1 of the outer ring resonator 131. In this case, the closed inner resonator 135 may be formed to have a circumferential length that is less than a circumferential length of the outer ring resonator 131. This is because, due to the difference between the width D2 and the width D1, the effective refractive index of the closed inner resonator 135 having a relatively large width D2 is greater than the effective refractive index of the outer ring resonator 131 having a relatively small width D1, and thus, the effective optical path lengths of the outer ring resonator 131 and the closed inner resonator 135 may be made equal to each other by reducing the circumferential length of the closed inner resonator 135. As described above, when the circumferential length of the closed inner resonator 135 is reduced, the degree of flexure of the second curved portion 135b having inward flexure may be reduced.

As another example, the layer thickness of the closed inner resonator 135 may be greater than or less than the layer thickness of the outer ring resonator 131. In this case, the width D2 of the closed inner resonator 135 may be formed to be less than or greater than the width D1 of the outer ring resonator 131 so that the effective refractive index of the closed inner resonator 135 is greater than the effective refractive index of the outer ring resonator 131. The circumferential length of the closed inner resonator 135 may be reduced by reducing the degree of flexure of the second curved portion 135b having inward flexure.

Since the complex structure resonator 130 includes a combination of the outer ring resonator 131 and the closed inner resonator 135 optically coupled to each other at the at least two points C1 and C2, the complex structure resonator 130 may have a free spectral range that is smaller than a free spectral range of the outer ring resonator 131 alone. Furthermore, the complex structure resonator 130 may have a free spectral range that is smaller than a free spectral range of the closed inner resonator 135 alone. For example, the complex structure resonator 130 may be provided to have half the free spectral range of the outer ring resonator 131 alone.

For example, when the free spectral ranges of the complex structure resonator 130, the outer ring resonator 131, and the closed inner resonator 135 are fsr, fsr1, and fsr2, respectively, fsr may be less than fsr1 and less than fsr2. For example, the effective optical path length of the outer ring resonator 131 may be equal to the effective optical path length of the closed inner resonator 135. In this case, fsr1 may be equal to fsr2 and the free spectral range fsr of the complex structure resonator 130 may be half the free spectral range fsr1 of the outer ring resonator 131, that is, fsr=(1/2)fsr1.

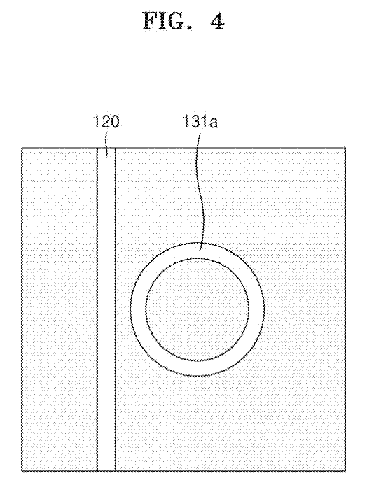

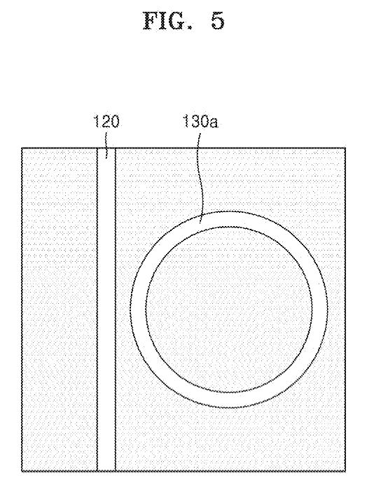

FIG. 4 is a plan view schematically illustrating a ring resonator 131a of Related Example 1, and FIG. 5 is a plan view schematically illustrating a ring resonator 130a of Related Example 2. It is considered that the ring resonator 131a of Related Example 1 of FIG. 4 and the ring resonator 130a of Related Example 2 of FIG. 5 have simple ring structures and have the same material, the same layer thickness and width of the ring resonator, and the same distance from the waveguide 120, except for the circumferential length. The ring resonator 130a of Related Example 2 has twice the ring size (ring circumferential length) of the ring resonator 131a of Related Example 1 so as to reduce fsr by half (1/2), compared to the ring resonator 131a of Related Example 1.

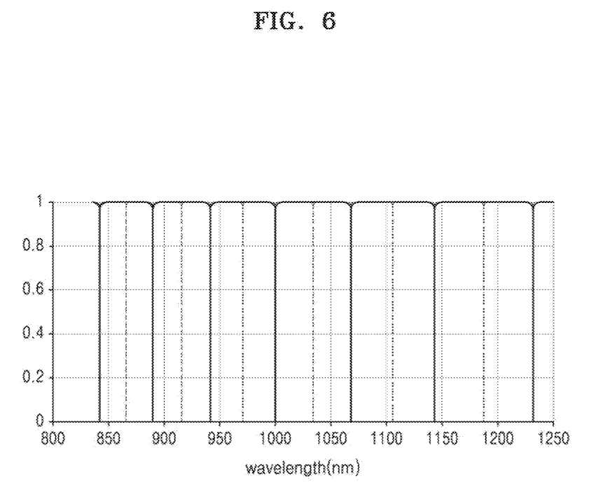

FIG. 6 is a graph showing transmission spectra of the ring resonator 131a of Related Example 1 of FIG. 4 and the ring resonator 130a of Related Example 2 of FIG. 5. In FIG. 6, a solid line indicates that the transmission spectrum of the ring resonator 131a of Related Example 1 overlaps the transmission spectrum of the ring resonator 130a of Related Example 2, and a dashed line indicates the transmission spectrum of the ring resonator 130a of Related Example 2 that is positioned between the transmission spectra of the ring resonator 131a of Related Example 1.

As seen from FIG. 6, when the ring size of the ring resonator 130a of Related Example 2 is twice the ring size of the ring resonator 131a of Related Example 1, fsr may be reduced by half and the transmission spectrum may appear at half intervals.

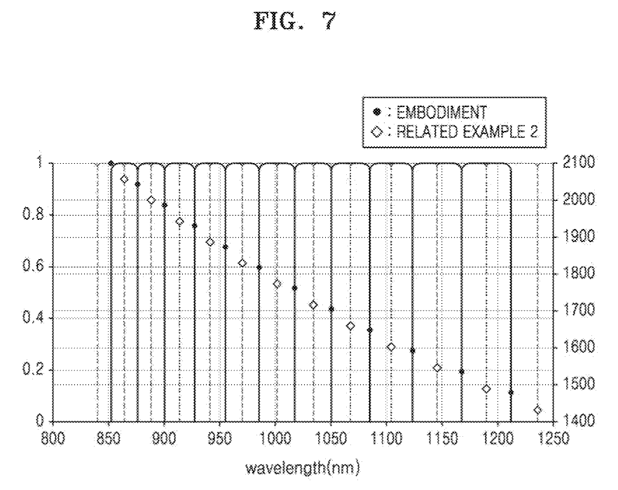

FIG. 7 shows a transmission spectrum of the ring resonator 130a of Related Example 2 of FIG. 5 and a transmission spectrum of the complex structure resonator 130 according to one or more embodiments. It is considered that the complex structure resonator 130 of one or more embodiments and the ring resonator 130a of Related Example 2 have the same material, the same layer thickness and width of the resonator structure, and the same distance from the waveguide 120. It is also considered that the circumferential length of each of the outer ring resonator 131 and the closed inner resonator 135 of the complex structure resonator 130 of one or more embodiments is equal to the circumferential length of the ring resonator 131a of Related Example 1, and an optical coupling constant between the outer ring resonator 131 and the closed inner resonator 135 is equal to an optical coupling constant between the outer ring resonator 131 and the waveguide 120.

Under these conditions, as seen from FIG. 7, the complex structure resonator 130 of one or more embodiments may have a smaller size than the ring resonator 130a of Related Example 2, while having fsr reduced by half, as in the ring resonator 130a of Related Example 2. However, it may be seen that fsr of the complex structure resonator 130 of one or more embodiments is shifted by 1/2.

As seen from the description of FIGS. 4 to 7, the complex structure resonator 130 of one or more embodiments is configured as a dual structure resonator including the outer ring resonator 131 and the closed inner resonator 135, which enables the implementation of a resonator having a relatively small size and a relatively dense fsr.

Optical characteristics (e.g., resonance peak intensity, a resonance wavelength, etc.) of the complex structure resonator 130 may change as at least one of the gap G between the waveguides 120 and 125 and the outer ring resonator 131 of the complex structure resonator 130 or an effective thickness H of the waveguides 120 and 125 changes. Therefore, it may be difficult to ensure desired accurate optical characteristics due to deviations in optical characteristics caused by changes occurring during the process of manufacturing the complex structure resonator 130. To solve this problem, a method of ensuring more accurate optical characteristics by controlling optical characteristics after the complex structure resonator 130 is manufactured may be taken into account.

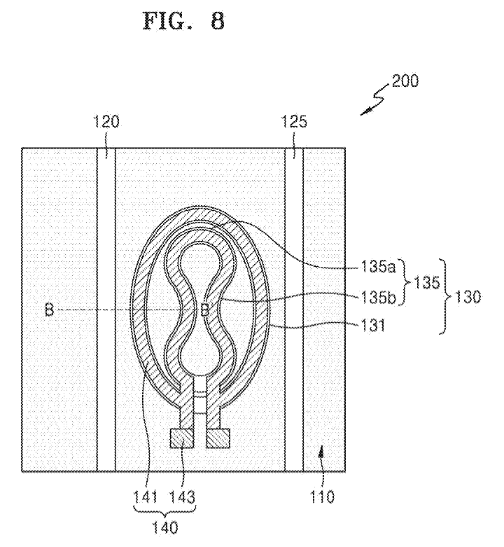

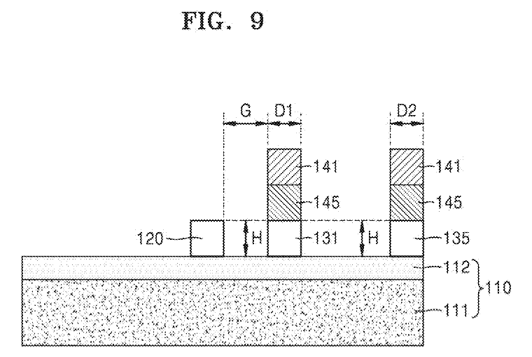

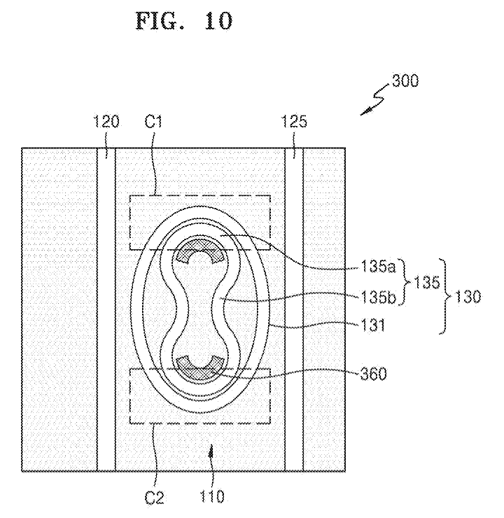

FIG. 8 is a plan view schematically illustrating a complex structure resonator 130 and a PIC 200 including the same, according to one or more embodiments, and FIG. 9 is a cross-sectional view taken along line B-B’ of FIG. 8. In FIGS. 8 and 9, components that are substantially the same as those in FIGS. 1 to 3 are denoted by the same reference numerals, and repetitive descriptions thereof are omitted as much as possible.

Referring to FIGS. 8 and 9, the complex structure resonator 130 and the PIC 200 including the same may further include an optical modulator 140 that modulates the wavelength or intensity of an optical signal transmitted through the complex structure resonator 130. The PIC 200 including the complex structure resonator 130 may include a substrate 110, waveguides 120 and 125 provided on the substrate 110 and configured to transmit light, the complex structure resonator 130 provided on the substrate 110 and optically coupled to the waveguides 120 and 125, and the optical modulator 140 configured to modulate the wavelength or intensity of the optical signal transmitted through the complex structure resonator 130. That is, the complex structure resonator 130 and the PIC 200 including the same may further include the optical modulator 140, compared to the complex structure resonator 130 and the PIC 100 including the same, which have been described with reference to FIGS. 1 to 3. The optical modulator 140 may or may not be included as a component of the complex structure resonator 130.

For example, the optical modulator 140 may be configured to control resonance conditions by transferring heat to the complex structure resonator 130 to change a temperature or by flowing current to the complex structure resonator 130 and to adjust an effective optical path length of the complex structure resonator 130. FIGS. 8 and 9 illustrate an example in which the optical modulator 140 transfers heat to the complex structure resonator 130 so as to change a temperature.

The optical modulator 140 may include, for example, a heating layer 141 that transfers heat to the complex structure resonator 130, and an electrode 143 that applies current to the heating layer 141. The heating layer 141 may include a material that generates heat when current is applied thereto, such as tungsten (W), but embodiments are not limited thereto. The electrode 143 may include a metal material, such as gold (Au), copper (Cu), or aluminum (Al), but the disclosure is not limited thereto.

As illustrated in FIG. 9, an insulating layer 145 may be further included between the heating layer 141 and a layer of the complex structure resonator 130. The insulating layer 145 is a layer to prevent light loss due to the heating layer 141 arranged on the complex structure resonator 130, and may include an insulating material capable of heat transfer, such as silicon oxide (SiO₂). The insulating layer 145 may be formed to a certain thickness of, for example, about 2 μm to about 4 μm, but embodiments are not limited thereto.

As another example, the optical modulator 140 may be implemented by doping impurities into the waveguide constituting the complex structure resonator 130 so that the effective optical path length is adjusted by flowing current to the complex structure resonator 130.

Since the optical modulator 140 is further included, optical characteristics (e.g., a resonance wavelength, resonance peak intensity, etc.) of the complex structure resonator 130 may be controlled when resonance conditions are adjusted by adjusting the effective optical path length of the complex structure resonator 130. Therefore, after the complex structure resonator 130 and the PIC 200 including the same are manufactured, desired optical characteristics may be accurately ensured by finely controlling resonance conditions of the complex structure resonator 130.

FIG. 10 is a plan view schematically illustrating a complex structure resonator 130 and a PIC 300 including the same, according to one or more embodiments. The complex structure resonator 130 and the PIC 300 including the same, which are illustrated in FIG. 10, are substantially the same as the complex structure resonator 130 and the PIC 100 including the same, according to one or more embodiments, which have been described with reference to FIGS. 1 to 3, except that a modulator 360 is further included. In FIG. 10, components that are substantially the same as those in FIGS. 1 to 3 are denoted by the same reference numerals, and repetitive descriptions thereof are omitted as much as possible.

Referring to FIG. 10, the modulator 360 may be provided inside (or around and/or adjacent to) the complex structure resonator 130 and configured to modulate optical characteristics (e.g., a phase, etc.) of light traveling through the complex structure resonator 130. To this end, the modulator 360 may include a thermo-optic modulator or an electro-optic modulator. The thermo-optic modulator may modulate a phase of light traveling through the closed inner resonator 135 and the outer ring resonator 131 of the complex structure resonator 130 by heating the complex structure resonator 130 through a heater. The electro-optic modulator may modulate a phase of light traveling through the closed inner resonator 135 and the outer ring resonator 131 of the complex structure resonator 130 by applying an electric field to the closed inner resonator 135 and the outer ring resonator 131 of the complex structure resonator 130.

FIG. 10 illustrates a case where the modulator 360 is provided inside the closed inner resonator 135 of the complex structure resonator 130, but this is only an example, and embodiments are not limited thereto. The modulator 360 may be provided outside the outer ring resonator 131 of the complex structure resonator 130, or may be provided inside the closed inner resonator 135 and outside the outer ring resonator 131. Furthermore, the modulator 360 may be formed in various shapes.

As described above, the complex structure resonator 130 and the PIC including the same, according to one or more embodiments, may further include the optical modulator 140 or the modulator 360 to control optical characteristics (e.g., a resonance wavelength, resonance peak intensity, etc.) of the complex structure resonator 130.

As another example, the complex structure resonator 130 and the PIC including the same, according to one or more embodiments, may include both the optical modulator 140 and the modulator 360 to control optical characteristics (e.g., a resonance wavelength, resonance peak intensity, etc.) of the complex structure resonator 130.

The complex structure resonators 130 and the PICs 100, 200, and 300 including the same, according to one or more embodiments, may be configured as follows.

The substrate 110 having a silicon layer on an upper surface thereof may be prepared. When the substrate 110 is an SOI substrate, the first material layer 111 may be the first silicon layer, and the insulating layer 112 and the second silicon layer may be sequentially stacked on the first silicon layer, and therefore, the substrate 110 having the silicon layer on the upper surface thereof may be prepared. The closed inner resonator 135 and the outer ring resonator 131 of the complex structure resonator 130 and the waveguides 120 and 125 may be formed by patterning the second silicon layer.

When the substrate 110 includes the first material layer 111 and the insulating layer 112, the second silicon layer may be formed on the insulating layer 112, and, the substrate 110 having the silicon layer on the upper surface thereof may be prepared. The second silicon layer may be formed by bonding the silicon layer of the SOI substrate and the insulating layer 112 to each other and removing the silicon substrate and the insulating layer of the SOI substrate. The bonding of the silicon layer of the SOI substrate and the insulating layer 112 to each other may be performed by, for example, silicon direct bonding (SDB). However, embodiments are not limited thereto. Thereafter, the waveguides 120 and 125 and the closed inner resonator 135 and the outer ring resonator 131 of the complex structure resonator 130 may be formed by patterning the second silicon layer.

As described above, after the closed inner resonator 135 and the outer ring resonator 131 of the complex structure resonator 130 and the waveguides 120 and 125 are formed, the optical modulator 140 described with reference to FIGS. 8 and 9 may be further formed, and/or the modulator 360 described with reference to FIG. 10 may be further formed.

To form the optical modulator 140, the insulating layer 145 may be formed on a waveguide of the complex structure resonator 130, for example, the closed inner resonator 135 and the outer ring resonator 131, the heating layer 141 may be formed on the insulating layer 145, and the electrode 143 may be formed to come into contact with the heating layer 141. The heating layer 141 may be formed on the waveguide of the complex structure resonator 130 and may extend onto the insulating layer 112 for connection to the electrode 143. The electrode 143 maybe formed on the insulating layer 112 so as to come into contact with the heating layer 141. The modulator 360 may be formed on the insulating layer 112 to be arranged inside the closed inner resonator 135 of the complex structure resonator 130 and/or outside the outer ring resonator 131 of the complex structure resonator 130.

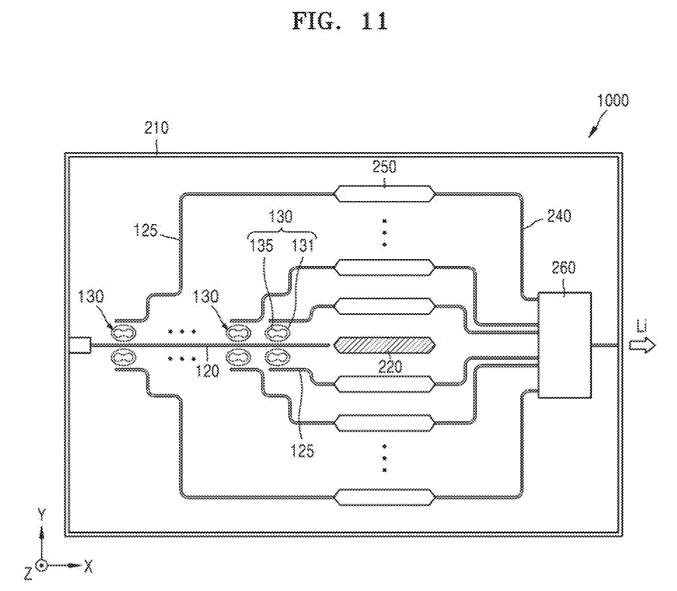

FIG. 11 is a plan view schematically illustrating a PIC 1000 including a complex structure resonator 130, according to one or more embodiments.

Referring to FIG. 11, the PIC 1000 may include a substrate 210, and at least one light source 220, at least one complex structure resonator 130, at least one optical element, and waveguides 120 and 125, which are provided on the substrate 210. The at least one optical element may include at least one of an optical amplifier 250, a waveguide 240, or an optical coupler 260. As illustrated in FIG. 11, the PIC 1000 according to one or more embodiments may include a plurality of complex structure resonators 130, but embodiments are not limited thereto. An example in which the PIC 1000 according to one or more embodiments includes the plurality of complex structure resonators 130 is described and illustrated.

The substrate 210 may include a first material layer, for example, a first silicon layer, and an insulating layer, as in the substrate 110 described with reference to FIG. 1. A second material layer, for example, a second silicon layer, may be formed on the substrate 210, and the plurality of complex structure resonator 130, the waveguides 120 and 125, etc. may be formed by patterning the second material layer. The substrate 210 may be, for example, a SOI substrate having a structure in which the first silicon layer, the insulating layer, and the second silicon layer are sequentially stacked in this stated order, and the plurality of complex structure resonators 130, the waveguides 120 and 125, etc. may be formed by patterning the second silicon layer.

The light source 220 may be a semiconductor laser device. The light source 220 may include a Group III-V compound semiconductor material. The light source 220 may include, for example, gallium nitride (GaN). The light source 220 may be a hybrid laser diode using heterogeneous integration of silicon and a Group III-V compound semiconductor. The light source 220 may be a Fabry-Perot hybrid laser diode. The light source 220 may include a multiple quantum well (MQW) structure or a quantum dot structure. The light source 220 may generate light having a certain wavelength range. For example, the light source 220 may be configured to generate light in an infrared wavelength range, for example, in a wavelength range of about 800 nm to about 1,750 nm.

The light source 220 may be arranged so that the emitted light is input to the waveguide 120. The light emitted from the light source 220 may be input to the waveguide 120. The input light may be optically coupled to the plurality of complex structure resonators 130 while traveling through the waveguide 120.

Each of the plurality of complex structure resonators 130 may be configured to operate as, for example, a ring filter. The plurality of complex structure resonators 130 may be optically coupled to the waveguide 120 through which light input from the light source 220 travels. The waveguide 125 may be provided on the opposite side of the plurality of complex structure resonators 130 and optically coupled to each of the plurality of complex structure resonators 130. A plurality of waveguides 125 may be provided to correspond to the plurality of complex structure resonators 130, respectively.

At least two of the plurality of complex structure resonators 130 may be provided to have different resonance conditions. Furthermore, some of the plurality of complex structure resonators 130 may be provided to have the same resonance conditions.

Among pieces of light transmitted through the waveguide 120, light of a wavelength band corresponding to the resonance condition of each of the plurality of complex structure resonators 130 may be transmitted to the corresponding waveguide 125 through the complex structure resonator 130, and light of the other wavelengths may be passed through as is. As described above, only light of a wavelength band matching the resonance conditions of each of the plurality of complex structure resonators 130 may be optically coupled to the corresponding waveguide 125 on the opposite side through the complex structure resonator 130 and travel through the waveguide 125. Each of the plurality of complex structure resonators 130 may act as a ring filter for light of a plurality of discontinuous wavelength bands. As described with reference to FIGS. 8 to 10, at least one of the optical modulator 140 or the modulator 360 may be further provided to additionally act as a ring modulator.

According to the PIC 1000 including the complex structure resonator 130, according to one or more embodiments, for example, only light of a wavelength band matching the resonance conditions of the plurality of complex structure resonators 130 travels through the plurality of waveguides 125, respectively. Accordingly, a multi-wavelength light source of a plurality of discontinuous wavelength bands may be implemented by a combination of the light source 220, the waveguide 120, the plurality of complex structure resonators 130, and the plurality of waveguides 125.

FIG. 11 illustrates an example in which the plurality of complex structure resonators 130 are arranged on the substrate 210 side-by-side in a direction opposite to a first direction (an X direction in FIG. 11) and optically coupled to the waveguide 120. The arrangement of the plurality of complex structure resonators 130 illustrated in FIG. 11 is only an example, and the plurality of complex structure resonators 130 may be variously arranged.

When the plurality of complex structure resonators 130 are arranged, the plurality of waveguides 125 may be provided to be optically coupled to the plurality of complex structure resonators 130, respectively. Light of a specific wavelength transmitted from each of the plurality of complex structure resonator 130 may be transmitted through the corresponding waveguide 125. The waveguide 125 may be provided between each of the plurality of complex structure resonators 130 and the optical amplifier 250 and optically couple each of the plurality of complex structure resonators 130 to the optical amplifier 250. The waveguide 240 may be provided between the optical amplifier 250 and the optical coupler 260 and optically couple the optical amplifier 250 to the optical coupler 260.

A plurality of optical amplifiers 250 may be provided on the substrate 210. For example, the plurality of optical amplifiers 250 may be provided on the substrate 210 along a second direction (a Y direction in FIG. 11) perpendicular to the first direction (the X direction in FIG. 11) and a direction opposite to the second direction (the Y direction in FIG. 11). Light input to each of the plurality of optical amplifiers 250 along each of the waveguides 125 may be amplified by the optical amplifier 250. The optical amplifier 250 may include a Group III-V compound semiconductor material. The optical amplifier 250 may include, for example, a semiconductor optical amplifier (SOA).

The optical coupler 260 may be provided on the substrate 210. For example, the optical coupler 260 may be provided on the substrate 210 along the first direction (the X direction in FIG. 11). Pieces of light amplified by the plurality of optical amplifiers 250 along the plurality of waveguides 125 may be transmitted to the optical coupler 260 through the plurality of waveguides 240, may be merged into one piece of light by the optical coupler 260, and may output the merged light. In FIG. 11, Li represents light output from the optical coupler 260. The light Li may be a combination of pieces of light of a plurality of discontinuous wavelength bands that are optically coupled from the waveguide 120 to each of the plurality of complex structure resonators 130, transmitted to the corresponding waveguides 125, amplified by each of the plurality of optical amplifiers 250, and then transmitted to the optical coupler 260 through the waveguides 240.

The PIC 1000 according to one or more embodiments may implement a multi-wavelength light source of a plurality of discontinuous wavelength bands with improved linewidth of each wavelength due to characteristics of the complex structure resonator 130.

The PIC 1000 according to one or more embodiments may transmit, to the plurality of optical amplifiers 250, light of a plurality of discontinuous wavelength bands that satisfy the resonance conditions of the plurality of complex structure resonators 130 with respect to light emitted from the light source 220 and input to the waveguide 120, and may adjust optical power for each wavelength by the plurality of optical amplifiers 250, thereby resolving an optical power imbalance between wavelengths. For example, light split according to wavelength through each of the plurality of complex structure resonators 130 may be individually amplified in optical power by the optical amplifier 250 optically coupled to each of the plurality of complex structure resonators 13 through the waveguide 125, thereby resolving an optical power imbalance between wavelengths.

Among the components included in the PIC 1000, the light source 220, the complex structure resonators 130, the waveguides 120, 125, and 240, the optical amplifiers 250, and the optical coupler 260 are illustrated in FIG. 11 for convenience of illustration and explanation, but other components or elements included in the PIC 1000, such as, for example, an optical splitter or a logic transistor, may be further provided on the substrate 210.

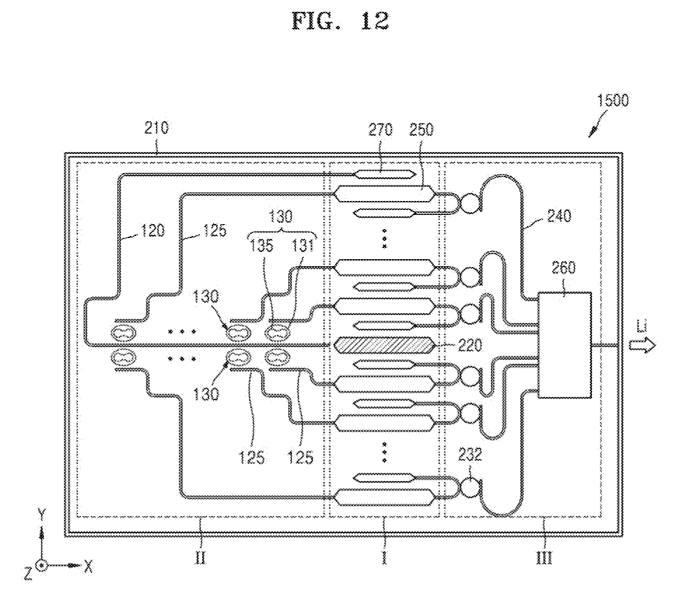

FIG. 12 is a plan view schematically illustrating a PIC 1500 including a complex structure resonator 130, according to one or more embodiments. Since the same reference numerals as those described with reference to FIG. 11 denote the same elements, descriptions thereof are omitted.

Referring to FIG. 12, the PIC 1500 may include a substrate 210, a light source 220 provided on the substrate 210, a waveguide 120, a plurality of complex structure resonators 130, a plurality of waveguides 125, and at least one optical element. The at least one optical element may include, for example, at least one of a ring modulator 232, a photodetector 270, an optical amplifier 250, a waveguide 240, and an optical coupler 260. For example, a plurality of optical amplifiers 250, a plurality of ring modulators 232, a plurality of photodetectors 270, and a plurality of waveguides 240 may be provided to correspond to the plurality of waveguides 125, respectively. A photodetector may be further provided to correspond to the waveguide 120. The photodetector 270 may include a photodiode. Pieces of light split by the plurality of complex structure resonators 130 may be individually amplified by the optical amplifier 250 and monitored by the photodetector 270 so that the optical power is controlled for each wavelength according to each longitudinal mode.

The photodetector 270 may include a Group III-V compound semiconductor material. The light source 220, the optical amplifier 250, and the photodetector 270 of the PIC 1500 may be provided in one region (hereinafter, a first region) I of the substrate 210. The first area I of the substrate 210 may be a central region of one surface of the substrate 210. The first region I of the substrate 210 may be, for example, a rectangular region having a certain width in the first direction (the X direction in FIG. 12) and a certain width in the second direction (the Y direction in FIG. 12). Optical elements other than the light source 220, the optical amplifier 250, and the photodetector 270 may be provided in region other than the first region I of the substrate 210.

In the PIC 1500 according to one or more embodiments, the optical elements requiring the Group III-V compound semiconductor material are integrated into the first region I of the substrate 210, which minimizes the amount of the Group III-V compound semiconductor material used in the substrate 210.

At least one of the complex structure resonator 130, the ring modulator 232, or the optical coupler 260 may be provided in a region (e.g., a second region II and a third region III) other than the first region I of the substrate 210. For example, the complex structure resonator 130 may be provided in the second region II positioned in a direction opposite to the first direction (the X direction in FIG. 12) of the first region I of the substrate 210, and the ring modulator 232 may be provided in the third region III positioned in the first direction (the X direction in FIG. 12) of the first region I of the substrate 210. Furthermore, the optical coupler 260 may be provided in the third region III positioned in the first direction (the X direction in FIG. 12) of the first region I of the substrate 210.

Since the PIC 1500 according to one or more embodiments further includes the ring modulator 232 in addition to the complex structure resonator 130, the linewidth of each wavelength may be further improved due to characteristics of the complex structure resonator 130, and a multi-wavelength light source with higher quality may be implemented. Furthermore, the photodetector 270 may be a reverse bias element. Since the photodetector 270, which is a reverse bias element, generates little heat, the photodetector 270 may be provided between the light source 220 and the optical amplifier 250. Furthermore, the ring modulator 232 may have a diameter of about 10 μm or less, and an increase in area of the PIC 1500 according to one or more embodiments may be less, compared to the PIC 1000 of FIG. 11.

The PICs 1000 and 1500 according to one or more embodiments described with reference to FIGS. 11 and 12 may provide a multi-wavelength light source of an integrated PIC with light source required when converting memory-to-memory communication, XPU (e.g., a central processing unit (CPU), a graphics processing unit (GPU), etc.)-to-memory communication, or XPU-to-XPU data transmission into an optical interconnection using a wavelength division multiplexing (WDM) scheme.

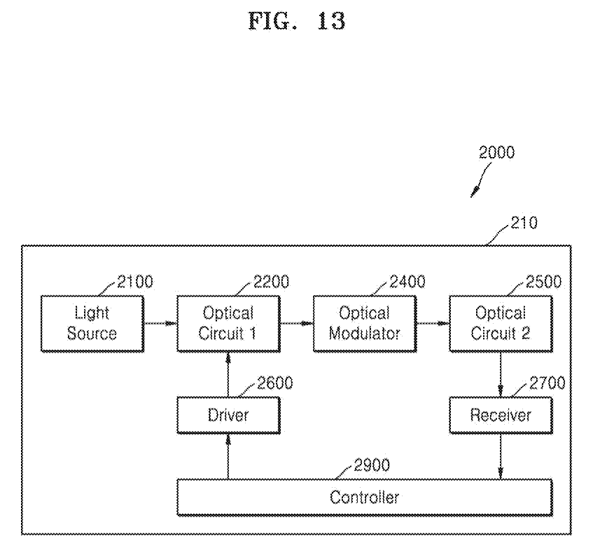

FIG. 13 is a block diagram illustrating a schematic configuration of a photoelectronic device 2000 according to one or more embodiments. The photoelectronic device 2000 of FIG. 13 may include a PIC, which constitutes an optical computing system, and may be, for example, a part of a component included in an artificial intelligence (AI) accelerator.

Referring to FIG. 13, the photoelectronic device 2000 may include a substrate 210, for example, a silicon substrate, a light source 2100 provided on the substrate 210, an optical modulator 2400 that outputs a determination signal determined according to a form in which light is input from the light source 2100, and a controller 2900 that controls a signal input to the optical modulator 2400 and processes an output from the optical modulator 2400.

The light source 2100 may emit, for example, laser light in an infrared wavelength band. The light source 2100 may include a multi-wavelength laser light source implemented by the PIC 1000 or the PIC 1500 described above. For example, the light source 2100 may output laser light having a plurality of discontinuous wavelength bands within a range of about 800 nm to about 1,750 nm.

The optical modulator 2400 may control output light by modulating incident light. On/off of the output light may be controlled, or on/off of the output light may be defined based on intensity of the output light. The optical modulator 2400 may be configured to modulate, for example, light in an infrared wavelength band. For example, an optical modulation layer of the optical modulator 2400 may include a quantum well structure including indium gallium arsenic phosphide (InGaAsP). Depending on a voltage applied to the optical modulator 2400, light of a specific wavelength band may be transmitted through the optical modulation layer, or may be at least partially absorbed by the optical modulation layer. The optical modulator 2400 may have, for example, a structure that is grown directly on the substrate 210. As another example, the optical modulator 2400 may be manufactured separately and integrated into the substrate 210. The optical modulator 2400 may be arranged in a plurality of arrays.

The photoelectronic device 2000 may further include an optical circuit optically coupled to an output terminal or an input terminal of the optical modulator 2400. For example, a first optical circuit 2200 may be provided between the light source 2100 and the optical modulator 2400, and a driver 2600 may be controlled by the controller 2900 and may apply a control signal to the first optical circuit 2200. Furthermore, a second optical circuit 2500 may be provided at the output terminal of the optical modulator 2400, and a signal of the second optical circuit 2500 may be transmitted to the controller 2900 through a receiver 2700. The first optical circuit 2200, the optical modulator 2400, and the second optical circuit 2500 may be part of an optical transmission system.

The first optical circuit 2200 may be configured to modulate and split light from the light source 2100. For example, the first optical circuit 2200 may be configured to modulate and split light from the light source 2100 into light of a number and intensity required for input to the optical modulator 2400, and may include an optical waveguide structure including one or more beam splitters and one or more phase retarders.

The second optical circuit 2500 may convert the output light from the optical modulator 2400 into an electrical signal. The second optical circuit 2500 may amplify the output light from the optical modulator 2400 and convert the amplified output light into an electrical signal.

The complex structure resonators 130 and the PICs 100, 200, 300, 1000, and 15000 including the same, according to one or more embodiments described above, may be implemented in a chip size.

Furthermore, the PICs 1000 and 1500 including the complex structure resonators 130, according to one or more embodiments described above, may be implemented in a form manufactured on a substrate, for example, a silicon substrate, and may be used as a multi-wavelength laser light source of a photoelectronic device including a PIC device, and a system applied in this way may be variously applied to systems requiring signal transmission, such as chip-to-chip, chip-to rack, or rack-to-rack.

Moreover, the PICs 1000 and 1500 including the complex structure resonators 130, according to one or more embodiments, may be manufactured on a substrate, for example, a silicon substrate, and may be used in a wide range of photoelectronic devices requiring an ultra-small multi-wavelength light source. In addition, since chip-size manufacturing including a multi-wavelength light source is possible, system cost reduction is possible.

The PICs 1000 and 1500 including the complex structure resonators 130, according to one or more embodiments, may be miniaturized and applied to photonic systems and optical communication fields, which require multi-wavelength light sources. For example, the PICs 1000 and 1500 including the complex structure resonators 130, according to one or more embodiments, may be applied to various photonic systems, from chip-to-chip to data center applications, to which an optical communication system of about 1,550 nm wavelength band is applied.

For example, the PICs 1000 and 1500 including the complex structure resonators 130, according to one or more embodiments, may apply memory-to-memory communication, XPU (e.g., a CPU, a GPU, etc.)-to-memory communication, or XPU-to-XPU data transmission as a multi-wavelength light source, such as an optical interconnection using a WDM scheme.

Furthermore, the PICs 1000 and 1500 including the complex structure resonators 130, according to one or more embodiments, may be applied to, for example, any mobile and stationary devices requiring large-capacity, high-speed data transmission or wideband data transmission. The mobile and stationary devices may include, for example, automobiles, drones, robot vacuum cleaners, inspection equipment, and industrial equipment.

The complex structure resonators 130 and the PICs 100, 200, 300, 1000, and 1500 including the same have been described with reference to the embodiments shown in the drawings, but these are only examples, and it will be understood by those of ordinary skill in the art that various modifications and equivalents may be made therefrom.

Moreover, the disclosure may have the following configurations.

According to one or more embodiments, there is provided a complex structure resonator including an outer ring resonator provided on a substrate and optically coupled to a waveguide and a closed inner resonator provided inside the outer ring resonator, wherein the closed inner resonator includes a first curved portion closer to the outer ring resonator and optically coupled to the outer ring resonator and a second curved portion farther away from the outer ring resonator.

The closed inner resonator of the complex structure resonator may include a plurality of first curved portions and a plurality of second curved portions and has a shape in which the first curved portion and the second curved portion are alternately arranged.

The outer ring resonator of the complex structure resonator may have a shape deformed from a circular shape.

An effective optical path length of the outer ring resonator of the complex structure resonator may be equal to an effective optical path length of the closed inner resonator.

The waveguide of the complex structure resonator may include a first waveguide provided on one side of the outer ring resonator and optically coupled to the outer ring resonator and a second waveguide provided on another side of the outer ring resonator and optically coupled to the outer ring resonator.

The complex structure resonator may have a free spectral range that is smaller than a free spectral range of the outer ring resonator.

The complex structure resonator may have half the free spectral range of the outer ring resonator.

According to one or more embodiments, there is provided a PIC including a substrate, a waveguide provided on the substrate and configured to transmit light, and a complex structure resonator including an outer ring resonator provided on the substrate and optically coupled to the waveguide and a closed inner resonator provided inside the outer ring resonator. The closed inner resonator includes a first curved portion closer to the outer ring resonator and optically coupled to the outer ring resonator and a second curved portion farther away from the outer ring resonator.

The closed inner resonator may include a plurality of first curved portions and a plurality of second curved portions and has a shape in which the first curved portion and the second curved portion are alternately arranged.

The outer ring resonator may have a shape deformed from a circular shape.

An effective optical path length of the outer ring resonator may be equal to an effective optical path length of the closed inner resonator.

The complex structure resonator may have a free spectral range that is smaller than a free spectral range of the outer ring resonator.

The complex structure resonator may have half the free spectral range of the outer ring resonator.

The waveguide may include a first waveguide provided on one side of the outer ring resonator of the complex structure resonator and optically coupled to the outer ring resonator of the complex structure resonator and a second waveguide provided on another side of the outer ring resonator of the complex structure resonator and optically coupled to the outer ring resonator of the complex structure resonator.

The complex structure resonator may include a plurality of complex structure resonators arranged along the first waveguide and optically coupled to the first waveguide, and the second waveguide may include a plurality of second waveguides corresponding to the plurality of complex structure resonator and optically coupled to the plurality of complex structure resonators, respectively.

The PIC may further include at least one optical element optically coupled to the complex structure resonator.

The at least one optical element may include at least one of a ring modulator, an optical coupler, or an optical amplifier.

According to one or more embodiments, there is provided a method of manufacturing a PIC, the method including preparing a substrate having a silicon layer on an upper surface thereof, and patterning the silicon layer of the substrate to form a complex structure resonator including a closed inner resonator and an outer ring resonator, and a waveguide optically coupled to the outer ring resonator of the complex structure resonator. The closed inner resonator includes a first curved portion closer to the outer ring resonator and optically coupled to the outer ring resonator and a second curved portion farther away from the outer ring resonator.

The closed inner resonator may include a plurality of first curved portions and a plurality of second curved portions and has a shape in which the first curved portion and the second curved portion are alternately arranged, and the outer ring resonator may have a shape deformed from a circular shape.

An effective optical path length of the outer ring resonator may be equal to an effective optical path length of the closed inner resonator.

The complex structure resonator according to one or more embodiments may be configured so that the outer ring resonator and the closed inner resonator are optically coupled to each other at at least two points, which constructs more transmission channels in a given wavelength range while having a smaller size.

The PIC according to one or more embodiments includes the complex structure resonator, which enables system miniaturization.

It should be understood that embodiments described herein should be considered in a descriptive sense only and not for purposes of limitation. Descriptions of features or aspects within each embodiment should typically be considered as available for other similar features or aspects in other embodiments. While embodiments have been described with reference to the figures, it will be understood by those of ordinary skill in the art that various changes in form and details may be made therein without departing from the spirit and scope as defined by the following claims and their equivalents.

What is claimed is:

1. A complex structure resonator comprising:
an outer ring resonator on a substrate, the outer ring resonator being configured to be optically coupled to a waveguide; and
a closed inner resonator inside the outer ring resonator,
wherein the closed inner resonator comprises:
a first curved portion at a first distance from the outer ring resonator, the first curved portion being configured to be optically coupled to the outer ring resonator; and
a second curved portion at a second distance from the outer ring resonator, the second distance being greater than the first distance.

2. The complex structure resonator of claim 1, wherein the closed inner resonator comprises a plurality of first curved portions and a plurality of second curved portions that are alternately provided.

3. The complex structure resonator of claim 1, wherein the outer ring resonator has a deformed circular shape.

4. The complex structure resonator of claim 1, wherein an effective optical path length of the outer ring resonator is equal to an effective optical path length of the closed inner resonator.

5. The complex structure resonator of claim 1, wherein the waveguide comprises:
a first waveguide on a first side of the outer ring resonator, the first waveguide being configured to be optically coupled to the outer ring resonator; and
a second waveguide on a second side of the outer ring resonator, the second waveguide being configured to be optically coupled to the outer ring resonator.

6. The complex structure resonator of claim 1, wherein a free spectral range of the complex structure resonator is smaller than a free spectral range of the outer ring resonator.

7. The complex structure resonator of claim 6, wherein the free spectral range of the complex structure resonator is half the free spectral range of the outer ring resonator.

8. A photonic integrated circuit (PIC) comprising:
a substrate;
a waveguide on the substrate and configured to transmit light; and
a complex structure resonator comprising:
an outer ring resonator on the substrate, the outer ring resonator being configured to be optically coupled to the waveguide; and
a closed inner resonator inside the outer ring resonator,
wherein the closed inner resonator comprises:
a first curved portion at a first distance from the outer ring resonator, the first curved portion being configured to be optically coupled to the outer ring resonator; and
a second curved portion at a second distance from the outer ring resonator, the second distance being greater than the first distance.

9. The PIC of claim 8, wherein the closed inner resonator comprises a plurality of first curved portions and a plurality of second curved portions that are alternately provided.

10. The PIC of claim 8, wherein the outer ring resonator has a deformed circular shape.

11. The PIC of claim 8, wherein an effective optical path length of the outer ring resonator is equal to an effective optical path length of the closed inner resonator.

12. The PIC of claim 8, wherein a free spectral range of the complex structure resonator is smaller than a free spectral range of the outer ring resonator.

13. The PIC of claim 12, wherein the free spectral range of the complex structure resonator is half the free spectral range of the outer ring resonator.

14. The PIC of claim 8, wherein the waveguide comprises:
a first waveguide on a first side of the outer ring resonator of the complex structure resonator, the first waveguide being configured to be optically coupled to the outer ring resonator of the complex structure resonator; and
a second waveguide on a second side of the outer ring resonator of the complex structure resonator, the second waveguide being configured to be optically coupled to the outer ring resonator of the complex structure resonator.

15. The PIC of claim 14, wherein the complex structure resonator comprises a plurality of complex structure resonators along the first waveguide, the plurality of complex structure resonators being configured to be optically coupled to the first waveguide, and
wherein the second waveguide comprises a plurality of second waveguides corresponding to the plurality of complex structure resonators, respectively, the plurality of second waveguides being configured to be optically coupled to the plurality of complex structure resonators, respectively.

16. The PIC of claim 8, further comprising at least one optical element being configured to be optically coupled to the complex structure resonator.

17. The PIC of claim 16, wherein the at least one optical element comprises at least one of a ring modulator, an optical coupler, and an optical amplifier.

18. A method of manufacturing a photonic integrated circuit (PIC), the method comprising:
preparing a substrate comprising a silicon layer on an upper surface of the substrate; and
patterning the silicon layer of the substrate to form a complex structure resonator and a waveguide, the complex structure resonator comprising a closed inner resonator and an outer ring resonator, and the waveguide being configured to be optically coupled to the outer ring resonator of the complex structure resonator,
wherein the closed inner resonator comprises:
a first curved portion at a first distance from the outer ring resonator, the first curved portion being configured to be optically coupled to the outer ring resonator; and
a second curved portion at a second distance from the outer ring resonator, the second distance being greater than the first distance.

19. The method of claim 18, wherein the closed inner resonator comprises a plurality of first curved portions and a plurality of second curved portions that are alternately provided, and
wherein the outer ring resonator has a deformed circular shape.

20. The method of claim 18, wherein an effective optical path length of the outer ring resonator is equal to an effective optical path length of the closed inner resonator.
